(19) United States
(12) Patent Application Publication
(10) Pub. No.: US 2025/0355325 A1
(43) Pub. Date: Nov. 20, 2025

(54) SHIELDING DEVICE AND CAMERA DEVICE COMPRISING SAME

(71) Applicant: Illinois Tool Works Inc., Glenview, IL (US)

(72) Inventor: Dongdong WANG, Min Hang District (CN)

(21) Appl. No.: 19/210,152

(22) Filed: May 16, 2025

(30) Foreign Application Priority Data
May 20, 2024 (CN) 2024106234514
May 14, 2025 (CN) 2025106184223

(51) Int. Cl. G03B 11/04

(52) U.S. Cl. CPC G03B 11/045

(57) ABSTRACT

A shielding device for a vehicle-mounted camera device having a camera. The shielding device includes a shielding member, a first motion actuating element, a second motion actuating element and a driving device. The shielding member has a closed position and an open position. The first motion actuating element and the shielding member are pivotably connected about a first axis. The first motion actuating element is rotatably mounted about a second axis and configured to drive the shielding member to rotate about the second axis relative to the camera. The second motion actuating element and the shielding member are pivotably connected at a distance from the first axis. The second motion actuating element drives the shielding member to flip relative to the camera about the first axis. The driving device is drivingly connected with the first motion actuating element and the second motion actuating element and configured to drive the first motion actuating element and the second motion. The shielding member is driven to rotate about the second axis and is concurrently driven to flip about the first axis, so as to move between the closed position and the open position.

### CROSS-REFERENCE TO RELATED APPLICATIONS

The present disclosure claims priorities to Chinese Patent Application No. 202410623451.4, filed on May 20, 2024, and entitled “Shielding Device”, and Chinese Patent Application No. 2025106184223, filed on May 14, 2025, and entitled “Shielding Device And Camera Device Comprising Same,” which are incorporated herein by reference in its entirety.

### TECHNICAL FIELD

The present disclosure relates generally to a shielding device and a camera device including the shielding device, and in particular to a vehicle-mounted camera device and a camera shielding device thereof.

### BACKGROUND

A vehicle-mounted camera device is used to image the environment outside a vehicle, so as to assist a vehicle driver in reversing, automatic parking, automatic driving of the vehicle, etc. The camera of the vehicle-mounted camera device is exposed to the outside and is easily contaminated by dust, bird droppings, etc. There is also a risk of damage to the camera. Some existing vehicle-mounted camera devices are provided with a movable shield plate as a shielding member. The shield plate moves between an open position and a closed position by translating between the side front and the direct front the camera or rotating between a position above the camera and a position in front of the camera. When the camera is not in operation, the shield plate is in the closed position and covers the camera to prevent contamination or damage to the camera. When the camera is in operation, the shield plate is in the open position, allowing the camera to be exposed to operate.

### SUMMARY

The present disclosure relates generally to a camera device, substantially as illustrated by and described in connection with at least one of the figures, as set forth more completely in the claims.

### BRIEF DESCRIPTION OF THE DRAWINGS

The foregoing and other objects, features, and advantages of the devices, systems, and methods described herein will be apparent from the following description of particular examples thereof, as illustrated in the accompanying figures; where like or similar reference numbers refer to like or similar structures. The figures are not necessarily to scale, emphasis instead being placed upon illustrating the principles of the devices, systems, and methods described herein.

FIG. 1A is a schematic perspective view of a camera device according to an embodiment of the present disclosure.

FIG. 1B is an exploded view of the camera device shown in FIG. 1A.

FIG. 2A is a side view of the camera device shown in FIG. 1A with a shielding member in an open position.

FIG. 2B is a side view of the camera device shown in FIG. 1A with the shielding member in an intermediate position.

FIG. 2C is a side view of the camera device shown in FIG. 1A with the shielding member in a closed position.

FIG. 2D is a sectional view taken along line D-D in FIG. 2C.

FIG. 3A is a schematic perspective view of a camera device according to another embodiment of the present disclosure.

FIG. 3B is an exploded view of the camera device shown in FIG. 3A.

FIG. 4A is a side view of the camera device shown in FIG. 3A with a shielding member in an open position.

FIG. 4B is a side view of the camera device shown in FIG. 3A with the shielding member in an intermediate position.

FIG. 4C is a side view of the camera device shown in FIG. 3A with the shielding member in a closed position.

### DETAILED DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y.” As another example, “x, y, and/or z” means any element of the seven-element set {(x), (y), (z), (x, y), (x, z), (y, z), (x, y, z)}. In other words, “x, y, and/or z” means “one or more of x, y, and z.”

It is desired that the camera of the vehicle-mounted performs 360° panoramic image capture. Accordingly, it is desired that the shielding member is not in the 360° image path of the camera when in the open position, avoiding obstructing the 360° panoramic image capture of the camera. The existing shielding member that translates between the side front and the direct front the camera will obstruct the lateral image capture of the camera when in the open position. As for the existing shielding member that rotates between a position above the camera and a position in front of the camera, a covering surface of the shielding member in the closed position can fit against a surface of a camera cover only if the covering surface of the shielding member and the surface of the camera cover are both formed into a spherical shape and the shielding member fits against the surface of the camera cover during the rotation. However, if the shielding member fits against the surface of the camera cover during the rotation, it may easily cause damage to the components. Further, the shielding member and the camera cover having non-spherical surfaces cannot fit against each other in the closed position, which is not conducive to the protection of the camera by means of the shielding member.

In order to at least partially solve the above technical problems, in a first aspect of the present disclosure, the present disclosure provides a shielding device for a vehicle-mounted camera device having a camera. The shielding device comprises a shielding member, a first motion actuating element, a second motion actuating element and a driving device. The shielding member has a closed position and an open position. The first motion actuating element and the shielding member are pivotably connected about a first axis. The first motion actuating element is rotatably mounted about a second axis and configured to drive the shielding member to rotate about the second axis relative to the camera. The second motion actuating element and the shielding member are pivotably connected at a distance from the first axis. The second motion actuating element is configured to drive the shielding member to flip relative to the camera about the first axis. The driving device is drivingly connected with the first motion actuating element and the second motion actuating element and configured to drive the first motion actuating element and the second motion. The shielding member is driven to rotate about the second axis and is concurrently driven to flip about the first axis, so as to move between the closed position and the open position.

In some embodiments, the shielding member covers the entire height range of the camera at one side of the camera when in the closed position, and the shielding member is outside the height range of the camera to expose the camera when in the open position.

In some embodiments, the first motion actuating element comprises a rotating arm having a first arm end and a second arm end opposite each other. The first motion actuating element is pivotably connected to the shielding member by means of the first arm end and is drivingly engaged with the driving device by means of the second arm end, so as to rotate the shielding member about the second axis under the drive of the driving device.

In some embodiments, the first motion actuating element comprises two of the rotating arms respectively located at opposite sides of the shielding member.

In some embodiments, the second motion actuating element comprises a first rod and a second rod rotatably connected to each other. The second motion actuating element is pivotably connected to the shielding member by means of the first rod and drivingly engaged with the driving device by means of the second rod, so as to flip the shielding member about the first axis under the drive of the driving device.

In some embodiments, the second motion actuating element comprises two sets of the first rod and the second rod, which are respectively located at opposite sides of the shielding member.

In some embodiments, the driving device has an output shaft which is engaged with the second rod. The shielding device further comprises a transmission device connecting the driving device to the rotating arm and configured to drive the rotating arm to rotate in the same direction as the second rod.

In some embodiments, the transmission device comprises a gear set.

In some embodiments, the gear set comprises a first gear connected to the output shaft and to the second rod, a second gear meshed with the first gear, and a third gear meshed with the second gear and connected to the rotating arm.

In some embodiments, the second gear is a single gear or a set of several gears.

In a second aspect of the present disclosure, the present disclosure provides a camera device for a vehicle. The camera device comprises a mounting seat, a camera disposed on the mounting seat, and a shielding device according to the present disclosure disposed on the mounting seat.

In a second aspect of the present disclosure, the present disclosure provides a shielding device for a vehicle-mounted camera device having a camera. The shielding device comprises a mounting seat, a shielding member, a first motion actuating element, a second motion actuating element and a driving device. The shielding member has a closed position and an open position and movable between the closed position and the open position. The first motion actuating element and the shielding member are pivotably connected about a first axis. The first motion actuating element is rotatably mounted on the mounting seat about a second axis and configured to drive the shielding member to rotate about the second axis relative to the camera. The second motion actuating element comprises a guide slot arranged on the mounting seat and a guide member arranged on the shielding member. The guide member is supported in the guide slot and slidable along the guide slot, such that the shielding member flips relative to the camera about the first axis while the first motion actuating element drives the shielding member to rotate. The driving device is drivingly connected with the first motion actuating element and configured to drive the first motion actuating element. The shielding member is driven to rotate about the second axis and is concurrently driven to flip about the first axis so as to move between the closed position and the open position.

In some embodiments, the shielding member covers the entire height range of the camera at one side of the camera when in the closed position, and the shielding member is outside the height range of the camera to expose the camera when in the open position.

In some embodiments, the guide slot is outside the height range of the camera at the one side of the camera.

In some embodiments, the shielding member comprises two of the guide members opposite each other. The mounting seat comprises two of the guide slots for respectively receiving the two guide members.

In some embodiments, the first motion actuating element comprises a rotating arm having a first arm end and a second arm end opposite to each other. The first motion actuating element is pivotably connected to the shielding member by means of the first arm end and engaged with an output shaft of the driving device by means of the second arm end, so as to rotate the shielding member about the second axis under the drive of the driving device.

In some embodiments, the first motion actuating element comprises two of the rotating arms, which are respectively located at opposite sides of the shielding member.

The shielding member of the present disclosure can simultaneously move away from the camera and turn toward the camera when moving from the closed position to the open position, and the shielding member can simultaneously move toward the camera and turn away from the camera when moving from the open position to the closed position. This enables the shielding member to fit against the surface of the camera cover when reaching the closed position, to provide reliable protection to the camera, but the shielding member does not touch the surface of the camera cover during movement, thereby avoiding damage to the components. Moreover, the covering surface of the shielding member and the surface of the camera cover are not be limited to a spherical shape, but can still fit against each other in the closed position of the shielding member. Furthermore, according to the present disclosure, the shielding member is not in the 360° image path of the camera when in the open position, thereby avoiding interference with the image capture of the camera.

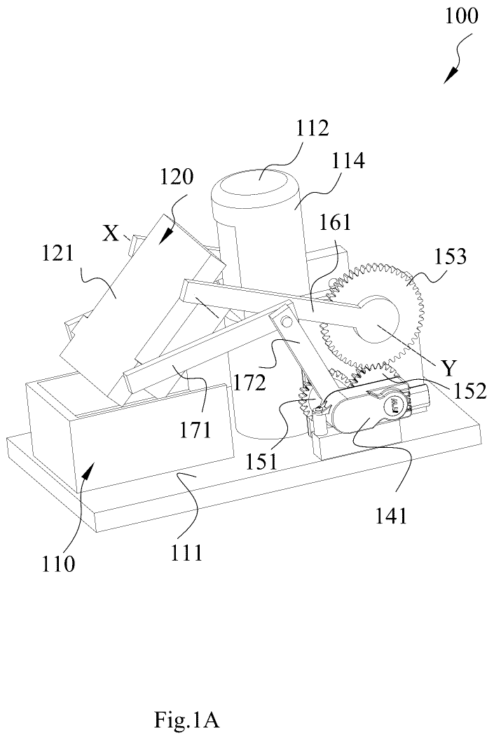

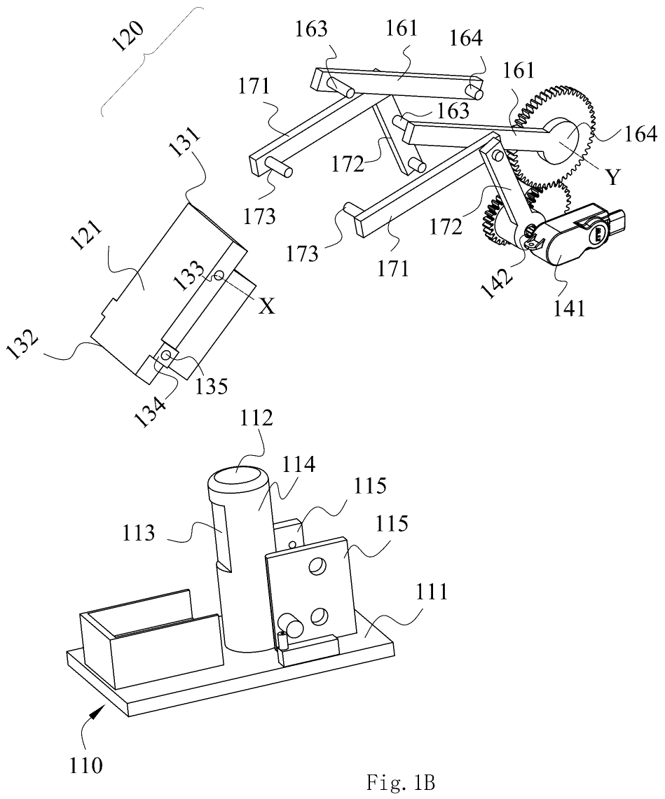

FIGS. 1A and 1B show the overall structure of a camera device 100 according to an embodiment of the present disclosure. FIG. 1A is a schematic perspective view of the camera device 100, and FIG. 1B is an exploded view of the camera device 100.

As shown in FIGS. 1A and 1B, the camera device 100 includes a mounting seat 110. A camera cover 112 extends from a base plate 111 of the mounting seat 110 and has a surface 114 provided with an opening 113. The camera cover 112 is provided with a camera (not shown) therewithin, which is aligned with the opening 113, to capture an image of the external environment through the opening 113. The shape of the opening 113 is shown schematically. In other embodiments, the opening 113 may extend along the perimeter of the camera cover 112, and the camera is rotatable along the entire perimeter of the opening 113 to implement the 360° panoramic image capture. The shapes and configurations of the mounting seat 110 and the camera cover 112 are shown schematically. In other embodiments, the mounting seat 110 and the camera cover 112 have other shapes and configurations.

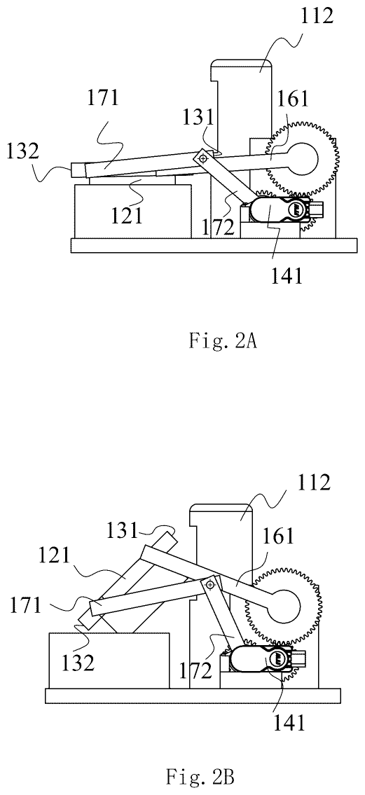

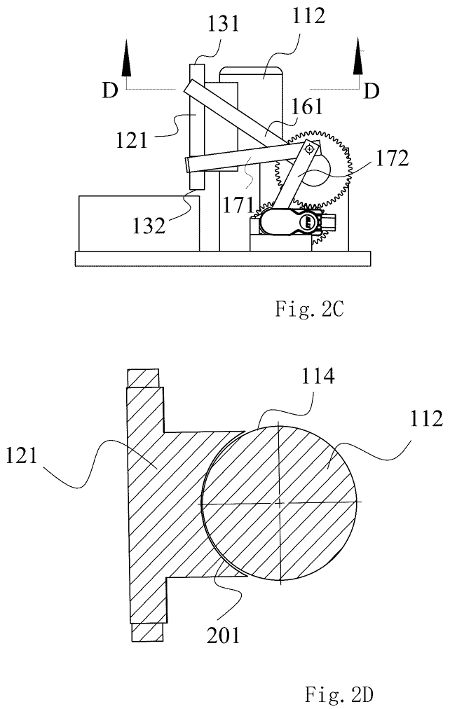

The camera device 100 includes a shielding device 120. The shielding device 120 is mounted to the mounting seat 110 by means of the mounting plates 115 on the mounting seat 110. The shielding device 120 includes a shielding member 121 and a driving device 141. The driving device 141 provides power for the movement of the shielding member 121. The driving device 141 has an output shaft 142 for outputting power. In an embodiment, the driving device 141 is an electric motor. The shielding member 121 has a closed position and an open position. The shielding member 121 moves between the open position (see FIG. 2A) and the closed position (see FIG. 2C) under the drive of the driving device 141. When the shielding member 121 is in the open position, the camera is exposed. When the shielding member 121 is in the closed position, the shielding member 121 covers the camera.

The shielding member 121 has a first end 131 and a second end 132 opposite to each other. When the shielding member 121 is in the open position, both the first end 131 and the second end 132 are located below the camera in a height direction of the camera, so that the shielding member 121 is outside the height range of the camera to expose the camera (see FIG. 2A). While in the closed position, the first end 131 is located above the camera in the height direction of the camera and the second end 132 is located below the camera so that the shielding member 121 covers the entire height range of the camera in front of the camera to shield the camera (see FIG. 2C). The shielding member 121 is provided with holes 133 serving as a first connecting portion on its opposite side surface, and projections 134 with holes 135 that are respectively at a distance from the two holes 133 serving as a second connecting portion. The first connecting portion and the second connecting portion are respectively used for connection with the first motion actuating element and the second motion actuating element described hereinafter, such that the shielding member 121 moves between the closed position and the open position under the drive of the driving device 141. The shielding member 121 has an axis X which passes through the centers of the holes 133, and the shielding member 121 can be driven to flip about the axis X, as will be described below. It should be understood that in other embodiments, the shielding member 121 is provided with a hole 133 and a projection 134 having the hole 135 only on one side surface. It should be understood that the first and second connecting portions may be configured in other form as long as the shielding member 121 can be driven to move.

The shielding device 120 includes a transmission device for connecting with the driving device 141 and transmits the power from the driving device 141. In the embodiment shown in the figures, the transmission device comprises a gear set, which includes a first gear 151, a second gear 152 and a third gear 153. The first gear 151 is engaged with the output shaft 142 of the driving device 141 and rotates clockwise or counterclockwise under the drive of the driving device 141. The first gear 151 meshes with the second gear 152 and rotates in the opposite direction to the first gear 151 under the drive by the rotation of the first gear 151. The third gear 153 meshes with the second gear 152 and thus can rotate in the opposite direction to the second gear 152 (i.e., in the same direction as the first gear 151) as the second gear 152 rotates. Although only one single second gear 152 is shown in the figures, the second gear 152 may be a set of several gears in other embodiments. It should be understood that different types of transmission device could be provided to transmit the power from the driving device 141.

The shielding device 120 includes a first motion actuating element connected to the driving device 141 through the transmission device so as to be driven by the driving device 141. The first motion actuating element having an axis Y. The first motion actuating element is connected to the shielding member 121 and rotatably mounted about the axis Y to drive the shielding member 121 to rotate about the axis Y relative to the camera. In the embodiment shown in the figures, the first motion actuating element includes two rotating arms 161, which are respectively located at two sides of the shielding member 121. The two rotating arms 161 are both provided with pins at the first arm ends 163 for insertion into the holes 133 on opposite sides of the shielding member 121, respectively, so that the two rotating arms 161 and the shielding member 121 are connected in a way that they can pivot relative to each other about the axis X. The second arm ends 164 of the two rotating arms 161 define the axis Y that passes through the centers of the second arm ends 164, and the two rotating arms 161 are rotatably mounted to the mounting plate 115 about the axis Y at the second arm ends 164. One of the rotating arms 161 is rotatably connected to the mounting plate 115 and to the third gear 153 at the second arm end 164, and rotates clockwise or counterclockwise about the axis Y as the third gear 153 rotates clockwise or counterclockwise. The rotation of this rotating arm 161 exerts a force on the shielding member 121 that drives the shielding member 121 to rotate toward or away from the camera about the axis Y, so as to drive the shielding member 121 to rotate toward or away from the camera about the axis Y to decrease or increase the distance from the camera. The other rotating arm 161 is rotatably connected to the mounting plate 115 at the second arm end 164, and rotates as the shielding member 121 moves. It should be understood that although two rotating arms 161 are provided as shown in the figure, in other embodiments, only one rotating arm 161 connected to the third gear 153 is provided.

The shielding device 120 includes a second motion actuating member connected with the driving device 141 so as to be driven by the driving device 141. The second motion actuating member is connected to the shielding member 121 to drive the shielding member 121 to flip about the axis X relative to the camera. In the embodiment shown in the figures, the second motion actuating member includes two sets of connecting rods respectively located at the two sides of the shielding member 121 and each including a first rod 171 and a second rod 172 rotatably connected to each other. The first rods 171 of the two sets of connecting rods are both provided with a pin 173 for insertion into the two holes 135 in the shielding member 121, respectively, so that the first rods 171 and the shielding member 121 are connected in a way that they can pivot relative to each other. The second rod 172 of one of the sets of connecting rods is engaged with the output shaft 142 of the driving device 141 and is connected to the first gear 151, so as to rotate clockwise or counterclockwise with the first gear 151 under the drive of the driving device 141. Since the third gear 153 rotates in the same direction as the first gear 151, the second rod 172 rotates in the same direction as the rotating arm 161. The rotation of this second rod 172 drives the connected first rod 171 to rotate in the same direction as the rotating arm 161. The rotation of the first rod 171 drives the shielding member 121 to flip about the axis X toward the upright direction such that the first end 131 of the shielding member 121 moves away from the camera, or toward the laid-down direction such that the first end 131 of the shielding member 121 moves toward from the camera. The second rod 172 of the other set of connecting rods is pivotably connected to the mounting plate 115, and the first rod 171 and the second rod 172 of the other set of connecting rods rotate as the shielding member 121 moves. It should be understood that although two sets of connecting rods are provided as shown in the figures, in other embodiments, only one set of connecting rods is provided. When the rotating arm 161 drives the shielding member 121 to rotate about the axis Y toward the camera to decrease the distance from the camera, the first rod 171 drives the shielding member 121 to flip about the axis X toward the upright direction such that the first end 131 of the shielding member 121 moves away from the camera; and when the rotating arm 161 drives the shielding member 121 to rotate about the axis Y away from the camera to increase the distance from the camera, the first rod 171 drives the shielding member 121 to flip about the axis X toward the laid-down direction such that the first end 131 of the shielding member 121 moves toward the camera.

FIGS. 2A to 2C show the movement of the shielding member 121 of the shielding device 100 from the open position to the closed position. In FIG. 2A, the shielding member 121 is in the open position. In FIG. 2B, the shielding member 121 is in an intermediate position. In FIG. 2C, the shielding member 121 is in the closed position. FIG. 2D is a sectional view taken along line D-D in FIG. 2C, showing the positional relationship between the shielding member 121 and the camera cover 112 when the shielding member 121 is in the closed position.

As shown in FIG. 2A, when the shielding member 121 is in the open position, the shielding member 121 is laid down. In the open position of the shielding member 121, the first end 131 and the second end 132 of the shielding member 121 are both located below the camera in the height direction of the camera, so that the shielding member 121 is outside the height range of the camera and the camera is thus exposed. In the open position, the shielding member 121 is spaced a distance from the camera cover 112, and the first end 131 of the shielding member 121 is closer to the camera cover 112 than the second end 132. In the embodiment shown in the figures, the shielding member 121 is substantially horizontal when in the open position. It should be understood that it is also possible that the shielding member 121 may be tilted as long as the camera can be exposed.

From FIGS. 2A to 2B, the shielding member 121 is driven to move from the open position to the intermediate position. In this process, the rotating arm 161, which is engaged with the gear 153 (see FIG. 1A), rotates clockwise about the axis Y (see FIGS. 1A and 1B) under the drive of the driving device 141, and thus drives the shielding member 121 to rotate about the axis Y toward the camera to decrease the distance between the shielding member 121 and the camera. Meanwhile, in this process, the second rod 172, which is engaged with the driving device 141, rotates clockwise under the drive of the driving device 141, and thus drives the first rod 171 to rotate. The first rod 171 in turn drives the shielding member 121 to flip about the axis X (see FIGS. 1A and 1B) toward the upright direction such that the first end 131 of the shielding member 121 moves away from the camera. As shown in FIG. 2B, when the shielding member 121 reaches the intermediate position, the shielding member 121 is tilted upwardly from the second end 132 to the first end 131, and is partially located in front of the camera, to cover part of the height range of the camera. When in the intermediate position, the shielding member 121 is still spaced a distance from the camera cover 112.

From FIGS. 2B to 2C, the shielding member 121 is driven from the intermediate position to the closed position. In this process, the rotating arm 161, which is engaged with the gear 153 (see FIG. 1A), further rotates clockwise about the axis Y (see FIGS. 1A and 1B) under the drive of the driving device 141, and thus drives the shielding member 121 to further rotate about the axis Y toward the camera to decrease the distance between the shielding member 121 and the camera. Meanwhile, in this process, the second rod 172, which is engaged with the driving device 141, further rotates clockwise under the drive of the driving device 141, and thus drives the first rod 171 to further rotate. The first rod 171 in turn drives the shielding member 121 to further flip about the axis X (see FIGS. 1A and 1B) toward the upright direction such that the first end 131 of the shielding member 121 moves away from the camera. As shown in FIG. 2C, when the shielding member 121 reaches the closed position, the shielding member 121 reaches the position where the first end 131 is above the camera and the second end 132 is below the camera, so that the shielding member 121 covers the entire height range of the camera in front of the camera, and the camera is thus completely covered. As further shown in FIG. 2D, the shielding member 121 has a covering surface 201. The covering surface 201 of the shielding member 121 and the surface 114 of the camera cover 112 fit against each other when the shielding member 121 is in the closed position, and the shielding member 121 thus provides reliable protection for the camera. FIG. 2D shows that the surface 114 of the camera cover 112 is cylindrical and the covering surface 201 of the shielding member 121 is arc-shaped, but in other embodiments, they may be configured into other shapes. In the embodiment shown in the figures, when the shielding member 121 is in the closed position, the shielding member 121 is vertical. It should be understood that in other embodiments, the shielding member 121 may be tilted when in the closed position as long as the covering surface 201 of the shielding member 121 and the surface 114 of the camera cover 112 fit against each other, and the shielding member 121 covers the camera.

It should be understood that the shielding member 121 moves from the closed position to the open position when performing the process from FIG. 2C to FIG. 2A. During the movement of the shielding member 121 from the closed position to the open position, the shielding member 121 is driven to rotate away from the camera to increase the distance from the camera, and meanwhile, the shielding member 121 is driven to flip about the axis X toward the laid-down direction such that the first end 131 of the shielding member 121 moves toward the camera.

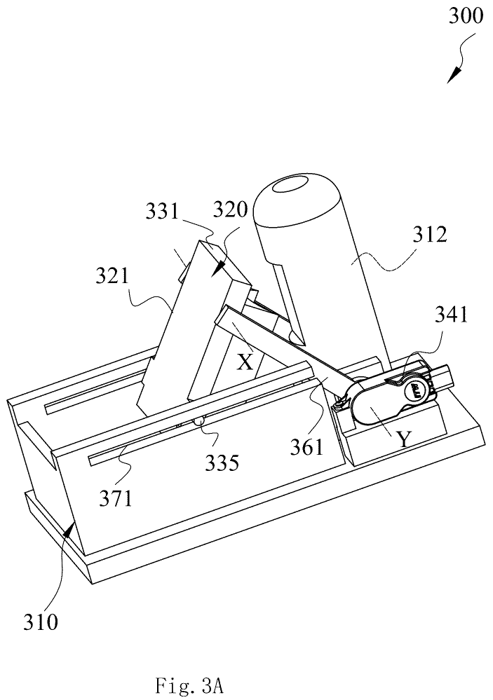

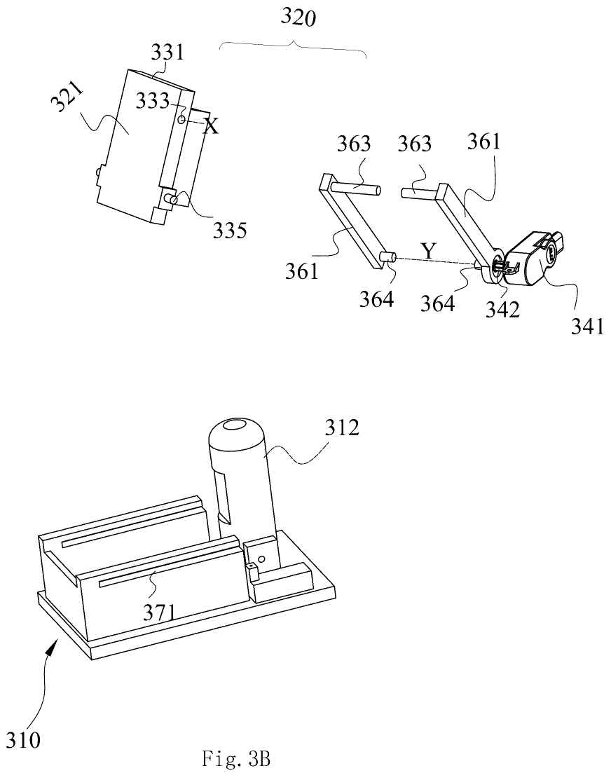

FIGS. 3A and 3B show the overall structure of a camera device 300 according to another embodiment of the present disclosure. FIG. 3A shows a schematic perspective view of the camera device 300, and FIG. 3B is an exploded view of the camera device 300. Similar to the camera device 100, the camera device 300 includes a shielding device 320. The shielding device 320 comprises a mounting seat 310. A camera is disposed in a camera cover 312 on the mounting seat 310. The differences between the camera device 300 and the camera device 100 will be described below.

As shown in FIGS. 3A and 3B, the mounting seat 310 is provided with two opposite guide slots 371. The two guide slots 371 are located in front of the camera, and below the camera so as to be outside the height range of the camera. The shielding device 320 includes a shielding member 321. As shown in the figures, in the shielding member 321, the two holes 135 in the shielding member 121 are replaced by two guide members 335 in the form of pin. The two guide members 335 are supported in the respective guide slots 371 and are slidable along the length of the guide slots 371. Different from the embodiment of the camera device 100, in the camera device 300, the guide members 335 and the guide slots 371 act as a second motion actuating member urging the shielding member 321 to flip about the axis X. It should be understood that the number of guide members 335 and the number of guide slots 371 may be set to one in other embodiments.

The shielding device 320 includes a driving device 341 and a first motion actuating element. The first motion actuating element is connected to the driving device 341 and is driven by the driving device 341. The first motion actuating element includes two rotating arms 361 located at two sides of the shielding member 321. The two rotating arms 361 are rotatably connected to the two opposite first connecting portions 333 of the shielding member 321 at the first arm ends 363 in the same manner as the rotating arms 161, such that the two rotating arms 361 and the shielding member 321 are pivotably connected. One of the rotating arms 361 is engaged with an output shaft 342 of the driving device 341 at the second arm end 363, and is driven by the driving device 341 to rotate clockwise or counterclockwise about the axis Y, and in turn exerts a force onto the shielding member 321 for rotating the shielding member 321 about the axis Y toward or away from the camera, to drive the shielding member 321 to rotate about the axis Y toward or away from the camera. The other rotating arm 361 is rotatably connected to the mounting seat 310 at the second arm end 364, and rotates as the shielding member 321 moves. It should be understood that the number of rotating arms 361 and the number of first connecting portions 333 may be set to one in other embodiments.

When the driving device 341 drives the rotating arm 361 engaged therewith to rotate about the axis Y, the rotating arm 361 exerts a force onto the shielding member 321 for rotating the shielding member 321 about the axis Y toward or away from the camera, to drive the shielding member 321 to rotate about the axis Y toward or away from the camera. Since the guide members 335 are received in the guide slots 371, the guide slots 371 and the guide members 335 cooperate with each other such that the guide members 335 slide along the guide slots 371 toward the camera to decrease distance between the shielding member 321 and the camera when the rotating arm 361 drives the shielding member 321 to rotate about the axis Y toward the camera, and meanwhile, the shielding member 321 flips about the axis X toward the upright direction to move the first end 331 of the shielding member 321 away from the camera; and the guide members 335 slide along the guide slots 371 away from the camera to increase distance between the shielding member 321 and the camera when the rotating arm 361 drives the shielding member 321 to rotate about the axis Y away from the camera, and meanwhile, the shielding member 321 flips about the axis X toward the laid-down direction to move the first end 331 of the shielding member 321 toward the camera.

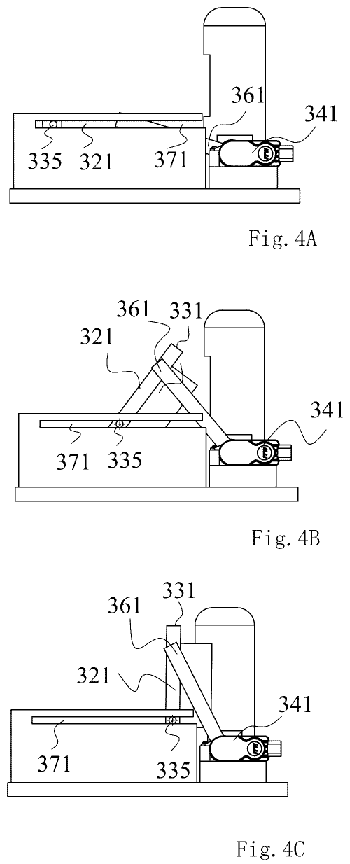

FIGS. 4A to 4C show the movement of the shielding member 321 from the open position to the closed position. In FIG. 4A, the shielding member 321 is in the open position. In FIG. 4B, the shielding member 321 is moved to the intermediate position. In FIG. 4C, the shielding member 321 is moved to the closed position.

When the shielding member 321 is in the open position as shown in FIG. 4A, the state of the shielding member 321 is similar to that of the shielding member 121 in the open position, exposing the camera. The guide members 335 of the shielding member 321 are located at a distal end of the guide slots 371 away from the camera.

From FIGS. 4A to 4B, the shielding member 321 moves from the open position to the intermediate position. In this process, the driving device 341 drives the rotating arm 361 engaged therewith to rotate about the axis Y (see FIGS. 3A and 3B) toward the camera. This rotating arm 361 thus exerts a force onto the shielding member 321 for rotating the shielding member 321 about the axis Y toward the camera, to drive the shielding member 321 to rotate toward the camera about the axis Y. During this process, with the cooperation of the guide slots 371 and the guide members 335, the guide members 335 slide along the guide slots 371 toward the camera to decrease distance between the shielding member 321 and the camera, and meanwhile, the shielding member 321 flips about the axis X (see FIGS. 3A and 3B) toward the upright direction to move the first end 331 of the shielding member 321 away from the camera, until the shielding member 321 reaches the intermediate position as shown in FIG. 4B. In the intermediate position, the state of the shielding member 321 is similar to that of the shielding member 121 in the intermediate position.

From FIGS. 4B to 4C, the shielding member 321 moves from the intermediate position to the closed position. In this process, the driving device 341 drives the rotating arm 361 engaged therewith to continue to rotate about the axis Y (see FIGS. 3A and 3B) toward the camera. This rotating arm 361 thus continues to exerts a force onto the shielding member 321 for rotating the shielding member 321 about the axis Y toward the camera, to drive the shielding member 321 to rotate toward the camera. During this process, with the cooperation of the guide slots 371 and the guide members 335, the guide members 335 continue to slide along the guide slots 371 toward the camera to decrease distance between the shielding member 321 and the camera, and meanwhile, the shielding member 321 continues to flip about the axis X (see FIGS. 3A and 3B) toward the upright direction to move the first end 331 of the shielding member 321 away from the camera, until the shielding member 321 reaches the closed position as shown in FIG. 4C. In the closed position, the state of the shielding member 321 is similar to that of the shielding member 121 in the closed position.

It should be understood that the process from FIG. 4C to FIG. 4A is performed when the shielding member 321 moves from the closed position to the open position. In the process, the guide slots 371 and the guide members 335 cooperate with each other such that when the rotating arm 361 exerts a force onto the shielding member 321 for rotating the shielding member 321 about the axis Y away from the camera to drive the shielding member 321 to rotate about the axis Y away from the camera, the guide members 335 slide along the guide slots 371 away from the camera to increase distance between the shielding member 321 and the camera, and meanwhile, the shielding member 321 flips toward the laid-down direction to move the first end 331 of the shielding member 321 toward the camera.

In the present disclosure, the shielding member is driven to flip to move its first end closer to the camera to move away from the camera during the movement of the shielding member from the open position to the closed position. In this way, although the distance between the shielding member and the camera cover decreases as the shielding member moves toward the camera during this process, the shielding member does not touch the camera cover before reaching the closed position. Moreover, during the movement of the shielding member from the closed position to the open position, the shielding member flips to move its first end closer to the camera to move toward the camera. However, during this process, the shielding member is concurrently driven to move away from the camera so that the shielding member and the camera cover are changed from fitting against each other to having a spacing therebetween, and the spacing increases gradually as the shielding member moves. Such a spacing provides space for the shielding member to flip. Therefore, the shielding member also does not touch the camera cover during the movement from the closed position to the open position. In conclusion, the shielding member does not touch the camera cover during the movement between the closed position and the open position, avoiding damage to the shielding member and the camera cover during the movement of the shielding member.

In the present disclosure, when the shielding member reaches the closed position, the covering surface of the shielding member and the surface of the camera cover fit against each other, and the shielding member thus provides reliable protection for the camera.

In addition, in the present disclosure, the shielding member is outside the height range of the camera when in the open position, so that the shielding member is not in the 360° image path of the camera, and the shielding member thus does not interfere with the 360° panoramic image capture of the camera when in the open position.

Although the present disclosure is described with respect to the examples of embodiments outlined above, various alternatives, modifications, variations, improvements, and/or substantial equivalents that are known or current or to be anticipated before long may be obvious to those of at least ordinary skill in the art. In addition, the technical effects and/or technical problems described in this specification are exemplary rather than limiting; Therefore, the disclosure in this specification may be used to solve other technical problems and have other technical effects and/or may solve other technical problems. Accordingly, the examples of the embodiments of the present disclosure as set forth above are intended to be illustrative rather than limiting. Various changes can be made without departing from the spirit or scope of the present disclosure. Therefore, the present disclosure is intended to include all known or earlier developed alternatives. modifications, variations, improvements and/or basic equivalents.

### Description of Main Reference Numerals

Camera device 100/300
Mounting seat 110/310
Base plate 111
Camera cover 112/312
Opening 113
Surface 114
Mounting plate 115
Shielding device 120/320
Shielding member 121/321
First end 131/331
Second end 132
Hole 133
Projection 134
Hole 135
Driving device 141/341
Output shaft 142/342
First gear 151
Second gear 152
Third gear 153
Rotating arm 161/361
First arm end 163/363
Second arm end 164/364
First rod 171
Second rod 172
Pin 173
Covering surface 201
Guide member 335
Guide slot 371

1. A shielding device for a vehicle-mounted camera device having a camera, comprising:
a shielding member having a closed position and an open position;
a first motion actuating element, the first motion actuating element and the shielding member being pivotably connected about a first axis, and the first motion actuating element being rotatably mounted about a second axis and configured to drive the shielding member to rotate about the second axis relative to the camera;
a second motion actuating element, the second motion actuating element and the shielding member being pivotably connected at a distance from the first axis, and the second motion actuating element being configured to drive the shielding member to flip relative to the camera about the first axis; and
a driving device drivingly connected with the first motion actuating element and the second motion actuating element and configured to drive the first motion actuating element and the second motion;
wherein the shielding member is driven to rotate about the second axis and is concurrently driven to flip about the first axis, so as to move between the closed position and the open position.

2. The shielding device according to claim 1, wherein the shielding member covers an entirety of a height range of the camera at one side of the camera when in the closed position, and the shielding member is outside the height range of the camera to expose the camera when in the open position.

3. The shielding device according to claim 2, wherein the first motion actuating element comprises a rotating arm having a first arm end and a second arm end opposite to each other, and the first motion actuating element is pivotably connected to the shielding member by means of the first arm end and is drivingly engaged with the driving device by means of the second arm end, so as to rotate the shielding member about the second axis under the drive of the driving device.

4. The shielding device according to claim 3, wherein the first motion actuating element comprises two of the rotating arms respectively located at opposite sides of the shielding member.

5. The shielding device according to claim 3, wherein the second motion actuating element comprises a first rod and a second rod rotatably connected to each other, the second motion actuating element being pivotably connected to the shielding member by means of the first rod and drivingly engaged with the driving device by means of the second rod, so as to flip the shielding member about the first axis under the drive of the driving device.

6. The shielding device according to claim 5, wherein the second motion actuating element comprises two sets of the first rod and the second rod, which are respectively located at opposite sides of the shielding member.

7. The shielding device according to claim 5,
wherein the driving device has an output shaft which is engaged with the second rod; and
wherein the shielding device further comprises a transmission device connecting the driving device to the rotating arm and configured to drive the rotating arm to rotate in the same direction as the second rod.

8. The shielding device according to claim 7, wherein the transmission device comprises a gear set.

9. The shielding device according to claim 7, wherein the gear set comprises:
a first gear connected to the output shaft and to the second rod;
a second gear meshed with the first gear; and
a third gear meshed with the second gear and connected to the rotating arm.

10. The shielding device according to claim 9, wherein the second gear is a single gear or a set of several gears.

11. A camera device for a vehicle comprising:
a mounting seat;
a camera disposed on the mounting seat; and
a shielding device according to claim 1 disposed on the mounting seat.

12. A shielding device for a vehicle-mounted camera device having a camera, comprising:
a mounting seat;
a shielding member having a closed position and an open position and movable between the closed position and the open position;
a first motion actuating element, the first motion actuating element and the shielding member being pivotably connected about a first axis, and the first motion actuating element being rotatably mounted on the mounting seat about a second axis and configured to drive the shielding member to rotate about the second axis relative to the camera;
a second motion actuating element comprising a guide slot arranged on the mounting seat and a guide member arranged on the shielding member, the guide member being supported in the guide slot and slidable along the guide slot, such that the shielding member flips relative to the camera about the first axis while the first motion actuating element drives the shielding member to rotate; and
a driving device drivingly connected with the first motion actuating element and configured to drive the first motion actuating element;
wherein the shielding member is driven to rotate about the second axis and is concurrently driven to flip about the first axis, so as to move between the closed position and the open position.

13. The shielding device according to claim 12, wherein the shielding member covers an entire height range of the camera at one side of the camera when in the closed position, and the shielding member is outside the height range of the camera to expose the camera when in the open position.

14. The shielding device according to claim 13, wherein the guide slot is outside the height range of the camera at the one side of the camera.

15. The shielding device according to claim 14, wherein the shielding member comprises two of the guide members opposite to each other, and the mounting seat comprises two of the guide slots for respectively receiving the two guide members.

16. The shielding device according to claim 15, wherein the first motion actuating element comprises a rotating arm having a first arm end and a second arm end opposite to each other, and the first motion actuating element is pivotably connected to the shielding member by means of the first arm end and engaged with an output shaft of the driving device by means of the second arm end, so as to rotate the shielding member about the second axis under the drive of the driving device.

17. The shielding device according to claim 16, wherein the first motion actuating element comprises two of the rotating arms, which are respectively located at opposite sides of the shielding member.
